(19) United States
(12) Patent Application Publication
(10) Pub. No.: US 2023/0359895 A1
(43) Pub. Date: Nov. 9, 2023

(54) TRAINING NEURAL NETWORKS USING SIGN AND MOMENTUM BASED OPTIMIZERS

(71) Applicant: Google LLC, Mountain View, CA (US)

(72) Inventors: Xiangning Chen, Los Angeles, CA (US); Chen Liang, Stanford, CA (US); Da Huang, Santa Clara, CA (US); Esteban Alberto Real, Sunnyvale, CA (US); Yao Liu, San Jose, CA (US); Kaiyuan Wang, Newark, CA (US); Yifeng Lu, Palo Alto, CA (US); Quoc V. Le, Sunnyvale, CA (US)

(21) Appl. No.: 18/313,291

(22) Filed: May 5, 2023

Related U.S. Application Data
(60) Provisional application No. 63/338,835, filed on May 5, 2022.

(51) Int. Cl. G06N 3/08

(52) U.S. Cl. CPC G06N 3/08

(57) ABSTRACT

Methods, systems, and apparatus, including computer programs encoded on computer storage media, for training a neural network to perform a machine learning task using a momentum and sign based optimizer.

### CROSS-REFERENCE TO RELATED APPLICATION

This application claims priority to U.S. Provisional Application No. 63/338,835, filed on May 5, 2022. The disclosure of the prior application is considered part of and is incorporated by reference in the disclosure of this application.

### BACKGROUND

This specification relates to training neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification generally describes a system that trains a neural network to perform a machine learning task.

The neural network is configured to perform the machine learning task by processing a network input in accordance with a set of weights of the neural network to generate a network output for the machine learning task. For example, the weights of the neural network include weights and, optionally, biases of the layers of the neural network.

During the training, the system updates the weights of the neural network by using an optimizer that maps current gradients and tracked momentum estimates to weight updates using a sign function.

Particular embodiments of the subject matter described in this specification can be implemented so as to realize one or more of the following advantages.

This specification generally describes an optimizer that is used to update the weights of a neural network during training of the neural network, i.e., an optimizer that maps the current gradients at a given training step to an update for the weights of the neural network.

State of the art neural networks have a large number of weights and therefore have a significant memory footprint during training. In particular, the memory consumed by the training has become a bottleneck on training, e.g., when the training is performed by a training system that distributes the training across multiple hardware accelerators, e.g., graphics processing units (GPUs), tensor processing units (TPUs), other ASICs, or some combination of ASICs and central processing units (CPUs). That is, the amount of available memory limits the size of the model that can be trained, delays the training as a result of loading values to and from the memory, or both.

The described optimizer addresses these issues by reducing the memory requirements of the training process.

In particular, the optimizer keeps track of only a single momentum estimate and leverages the sign operation to calculate the update to the weights. Because of this, the optimizer has a significantly lower memory requirement during training relative to other commonly used, state of the art optimizers. For example, optimizers like AdamW track estimates of both the first and second moment. When the neural network has a large number of weights, tracking a respective estimate for multiple moments for each weight consumes a significant amount of the available memory, even when training is performed by a distributed training system. Thus, the described optimizer cuts the memory requirement in half relative to AdamW and similar optimizers, removing significant bottlenecks to the training of the neural network. That is, by using this technique, less of the available memory of the training system needs to be consumed by the optimizer.

Despite this significant memory savings, the described optimizer outperforms these common state of the art optimizers for training a variety of neural networks on different tasks, e.g., for training vision models on different computer vision (“image processing”) tasks or training language models for various language modeling or natural language processing tasks.

Notably, the improvement increases with the size of the model, which makes the described optimizer particularly well-suited for training even larger models where the memory bottleneck described above plays an even greater role during training.

Further, using the described optimizer can enable the training to converge to smoother regions and is robust to hyperparameter choices, further improving the quality of the trained neural network and making the training process more efficient.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example neural network training system.

FIG. 2 is a flow diagram of an example process for performing a training iteration.

FIG. 3 shows pseudo code for one example of the optimizer.

FIG. 4 shows the performance of neural networks trained using the described optimizer.

Like reference numbers and designations in the various drawings indicate like elements.

### DETAILED DESCRIPTION

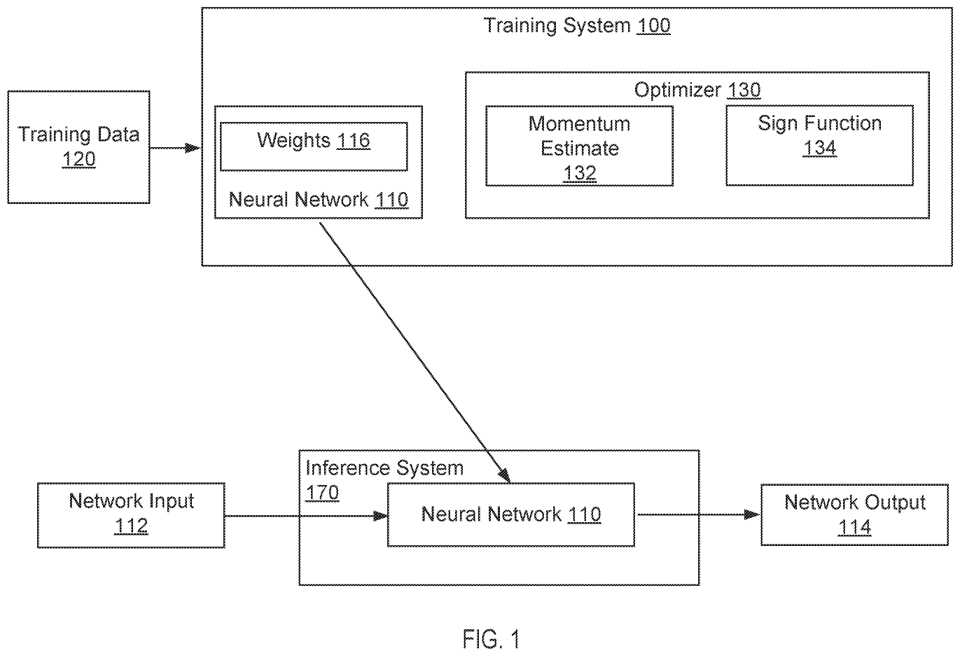

FIG. 1 shows an example neural network training system 100. The system 100 is an example of a system implemented as computer programs on one or more computers in one or more locations, in which the systems, components, and techniques described below can be implemented.

The training system 100 is a system that trains a neural network 110 on training data 120 to perform a machine learning task.

The neural network 110 is configured to perform the machine learning task by processing a network input in accordance with a set of weights 116 of the neural network 110 to generate a network output for the machine learning task.

For example, the weights 116 of the neural network 110 include weights and, optionally, biases of the layers of the neural network 110.

The neural network 110 can be trained to perform any kind of machine learning task, i.e., can be configured to receive any kind of digital data input and to generate any kind of score, classification, or regression output based on the input.

In some cases, the neural network 110 is a neural network that is configured to perform an image processing task, i.e., receive an input image and to process the intensity values of the pixels of the input image to generate a network output for the input image. For example, the task may be image classification and the output generated by the neural network 110 for a given image may be scores for each of a set of object categories, with each score representing an estimated likelihood that the image contains an image of an object belonging to the category. As another example, the task can be image embedding generation and the output generated by the neural network 110 can be a numeric embedding of the input image. As yet another example, the task can be object detection and the output generated by the neural network 110 can identify locations in the input image at which particular types of objects are depicted. As yet another example, the task can be image semantic segmentation and the output generated by the neural network 110 can assign each pixel of the input image to a category from a set of categories. As yet another example, the task can be image instance segmentation and the output generated by the neural network 110 can assign each pixel of the input image to a respective object instance from a set of object instances. As yet another example, the task can be image depth prediction and the output generated by the neural network 110 can assign a respective predicted depth value to each pixel of the input image.

As another example, if the inputs to the neural network 110 are Internet resources (e.g., web pages), documents, or portions of documents or features extracted from Internet resources, documents, or portions of documents, the task can be to classify the resource or document, i.e., the output generated by the neural network 110 for a given Internet resource, document, or portion of a document may be a score for each of a set of topics, with each score representing an estimated likelihood that the Internet resource, document, or document portion is about the topic.

As another example, if the inputs to the neural network 110 are features of an impression context for a particular advertisement, the output generated by the neural network 110 may be a score that represents an estimated likelihood that the particular advertisement will be clicked on.

As another example, if the inputs to the neural network 110 are features of a personalized recommendation for a user, e.g., features characterizing the context for the recommendation, e.g., features characterizing previous actions taken by the user, the output generated by the neural network 110 may be a score for each of a set of content items, with each score representing an estimated likelihood that the user will respond favorably to being recommended the content item.

As another example, if the input to the neural network 110 is a sequence of text in one language, the output generated by the neural network 110 may be a piece of text in the other language that is a predicted proper translation of the input text into the other language.

As another example, the task may be an audio processing task.

For example, if the input to the neural network 110 is a sequence representing a spoken utterance, the output generated by the neural network 110 may be a text transcript for the utterance.

As another example, the task may be a keyword spotting task where, if the input to the neural network 110 is a sequence representing a spoken utterance, the output generated by the neural network 110 can indicate whether a particular word or phrase (“hotword”) was spoken in the utterance.

As another example, if the input to the neural network 110 is a sequence representing a spoken utterance, the output generated by the neural network 110 can identify the natural language in which the utterance was spoken.

As another example, the task can be a natural language processing or understanding task, e.g., an entailment task, a paraphrase task, a textual similarity task, a sentiment task, a sentence completion task, a grammaticality task, and so on, that operates on a sequence of text in some natural language.

As another example, the task can be a text to speech task, where the input is text in a natural language or features of text in a natural language and the network output is a spectrogram or other data defining audio of the text being spoken in the natural language.

As another example, the task can be a health prediction task, where the input is electronic health record data for a patient and the output is a prediction that is relevant to the future health of the patient, e.g., a predicted treatment that should be prescribed to the patient, the likelihood that an adverse health event will occur to the patient, or a predicted diagnosis for the patient.

As another example, the task can be an agent control task, where the input is an observation characterizing the state of an environment and the output defines an action to be performed by the agent in response to the observation. The agent can be, e.g., a real-world or simulated robot, a control system for an industrial facility, or a control system that controls a different kind of agent.

The neural network 110 can generally have any appropriate architecture for performing the machine learning task. Examples of neural network architectures that the neural network 110 can have include convolutional architectures, recurrent architectures, fully-connected architecture, e.g., multi-layer perceptron (MLP) architectures, encoder-only Transformer architectures, encoder-decoder Transformer architectures, decoder-only Transformer architectures, other attention-based architectures, and so on.

The training data 120 includes multiple training examples which, in turn, each include a training input and a corresponding target output for the training input for the machine learning task, i.e., a target output to be generated by the neural network 110 by processing the training input

Generally, the system 100 trains the neural network 110 to minimize a loss function for the machine learning task.

The loss function can be any appropriate loss function for the machine learning task. Generally, however, the loss function includes one or more terms that measure, for each training input, the quality of a training output for the training input generated by performing a forward pass through the neural network, e.g., relative to a respective target output for the training input. For example, the one or more terms can be cross entropy loss terms, mean squared error loss terms, negative log likelihood loss terms, and so on.

The loss function can also include other terms, e.g., regularization terms, auxiliary loss terms, unsupervised learning loss terms, and so on, that do not depend on the target outputs for the training inputs.

More specifically, the system 100 performs the training over a plurality of update iterations. At each update iteration, the system 100 updates the weights of the neural network 110 using a plurality of training examples (a “batch” or a “mini-batch” of training examples) sampled from the training data 120.

Thus, by repeatedly performing update iterations, the system 100 repeatedly updates the weights of the neural network 110 to determine weights that will cause the neural network 110 to perform well on the machine learning task.

More specifically, at each iteration, the system 100 computes, using the plurality of training examples, a current gradient of the loss function for the machine learning task with respect to each of the weights of the neural network 110.

The system 100 then uses a sign and momentum based optimizer 130 to determine an update to the weights from the current gradient.

As will be described in more detail below, for each weight, the optimizer 130 keeps track of only a single momentum estimate 132, e.g., an estimate of the first moment, e.g., the expected value, of the gradient of the loss function with respect to the weight across the update iterations, and, at each update iteration, leverages a sign function 134 to calculate the update to the weights from the current gradients and the tracked momentum estimates. This is in contrast to other optimizers that need to keep track of multiple values for each weight, e.g., estimates of both the first and second moment of the weight.

The sign function 134 is a function that maps values having a positive sign to a first value, e.g., 1, values that are equal to zero to a second value, e.g., 0, and values that have a negative sign to a third value, e.g., −1. That is, the output of the sign function for a given input depends only on the sign of the given input and not on the magnitude of the given input.

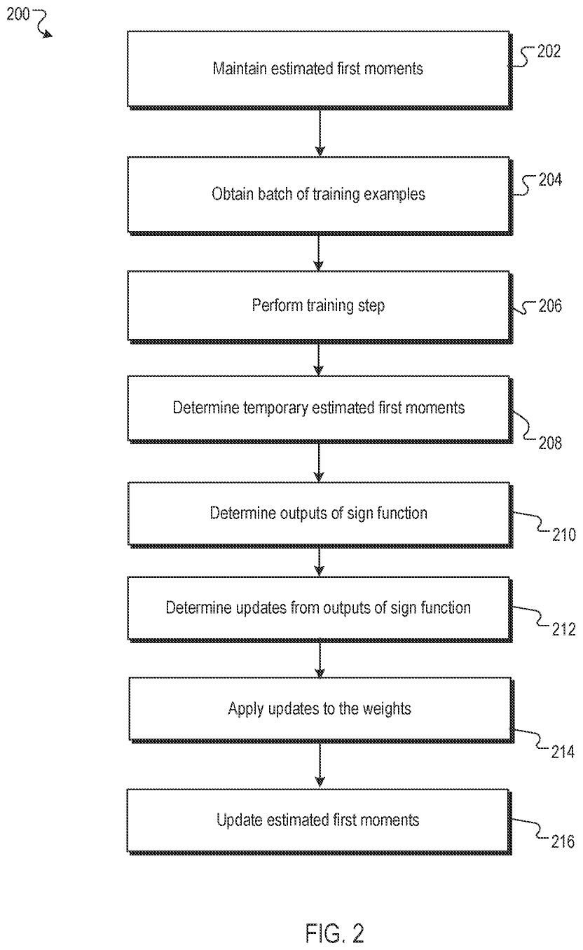

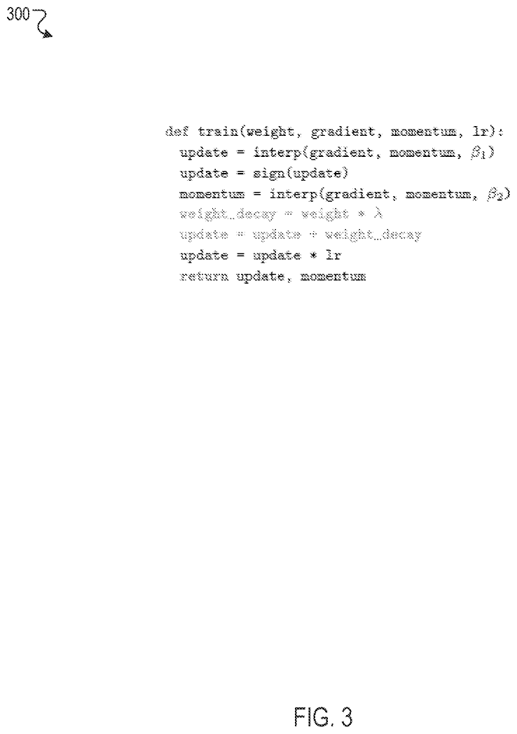

Updating the weights at each update iteration is described in more detail below with reference to FIGS. 2 and 3.

After training, the training system 100 or a different inference system 170 deploys the trained neural network 110 on one or more computing devices to perform inference, i.e., to generate new network outputs 114 for the machine learning task for new network inputs 112. Optionally, the training system 100 or the different inference system 170 can further fine-tune some or all of the weights of the neural network 110 before deploying the neural network 110, e.g., using a different optimizer or on a different objective.

FIG. 2 is a flow diagram of an example process 200 for performing an update iteration. For convenience, the process 200 will be described as being performed by a system of one or more computers located in one or more locations. For example, a neural network training system, e.g., the neural network training system 100 of FIG. 1, appropriately programmed, can perform the process 200.

The system can repeatedly perform iterations of the process 200 to repeatedly update the weights of the neural network until a termination criterion has been satisfied, e.g., until a threshold number of iterations of the process 200 have been performed, until a threshold amount of wall clock time has elapsed, or until the values of the weights have converged.

The system maintains, for each of the weights of the neural network, a respective estimated first moment of a gradient of the loss function for the machine learning task with respect to the weight (step 202). For example, the estimated first moment can be a moving average of the gradient of the loss function with respect to the weight that is updated at every update iteration.

That is, the system maintains, for each weight, a respective estimate of the first moment of the gradient with respect to the weight up to the current update iteration.

Prior to beginning training, the system initializes the estimate for each weight, e.g., to zero, and then updates the estimate at each update iteration during the training. Updating the estimate will be described in more detail below.

As described above, the loss function can be any appropriate loss function for the machine learning task. Generally, the loss function includes one or more terms that measure, for each training input, the quality of a training output for the training input generated by performing a forward pass through the neural network, e.g., relative to a respective target output for the training input. For example, the one or more terms can be cross entropy loss terms, mean squared error loss terms, negative log likelihood loss terms, and so on.

The loss function can also include other terms, e.g., regularization terms, auxiliary loss terms, unsupervised learning loss terms, and so on, that do not depend on the target outputs for the training inputs.

The system obtains a batch that includes a plurality of training examples (step 204). Each training example includes a training input and a target output for each training input. The system will generally obtain different training examples at different iterations, e.g., by sampling a fixed number of examples from a larger set of training data at each iteration.

The system performs, using the plurality of training examples, a training step to obtain respective current gradients of the loss function with respect to each of the weights of the neural network (step 206).

For example, the system can perform a forward pass through the neural network using the training examples and then perform a backward pass through the neural network to compute the respective current gradients through backpropagation.

The system determines, for each weight, a respective temporary estimated first moment from the respective estimated first moment of the gradient for the weight and the respective current gradient of the loss function with respect to the weight (step 208).

Generally, the system computes the respective temporary estimated first moment for each weight by computing, in accordance with a first interpolation weight, an interpolation between (i) a quantity derived from the respective estimated first moment of the gradient for the weight and (ii) the respective current gradient of the loss function with respect to the weight.

In some implementations, the system uses a bias corrected version of the respective estimated first moment for the weight to compute the temporary estimated first moment for the weight. To compute the bias corrected version of the estimated first moment, the system can divide the estimated first moment by (one—the first or second interpolation weight raised to the t-th power, where t is an index assigned to the current iteration of the process 200).

Thus, in these implementations, to determine, for each weight, the respective temporary estimated first moment the system can compute, in accordance with the first interpolation weight, an interpolation between (i) a bias corrected version of the respective estimated first moment of the gradient for the weight and (ii) the respective current gradient of the loss function with respect to the weight.

In some other implementations, the system directly uses the respective estimated first moment. That is, unlike other optimizers, the system refrains from needing to compute a bias correction for the estimated first moment.

Thus, in these implementations, to determine, for each weight, the respective temporary estimated first moment, the system can compute, in accordance with the first interpolation weight, an interpolation between (i) the respective estimated first moment of the gradient for the weight and (ii) the respective current gradient of the loss function with respect to the weight.

As will be described in more detail below, the temporary estimated first moment is referred to as “temporary” because the system does not persist the temporary estimated first moment across update iterations and only uses the temporary estimated first moment to determine the weight update at the iteration at which it is computed.

The system determines, for each weight, an output of a sign function applied to the respective temporary estimated first moment for the weight (step 210).

A sign function is a function that maps values having a positive sign to a first value, e.g., 1, values that are equal to zero to a second value, e.g., 0, and values that have a negative sign to a third value, e.g., −1. That is, the output of the sign function for a given input depends only on the sign of the given input and not on the magnitude of the given input.

The system then determines, for each weight, a respective update from the output of the sign function applied to the respective temporary estimated first moment for the weight (step 212).

Thus, due to the use of the sign function, the magnitude of the contribution of the current gradient and the estimated first moment to the update is uniform across all weights, i.e., because the sign function only considers the sign of a value and not the magnitude of the value in determining its output. That is, because the only impact that the current gradient and the estimated first moment have on the computation of the update for the weight is through the computation of the output of the sign function (and the sign function depends only on sign and not on magnitude), the magnitude of the contribution of the current gradient and the estimated first moment to the update is uniform across all weights.

As one example, the respective update can be the product of the output of the output of the sign function applied to the respective temporary estimated first moment for the weight and a respective learning rate for the weight.

The learning rate for the weight is generally received as input by the system and can be, e.g., a constant value that is the same for all of the weights at all of the update iterations, a constant value that is different for different ones of the weights, a dynamic value that is adjusted according to a schedule that depends on an index of the current update iteration, and so on.

As another example, the system can determine the respective update from (i) the output of the sign function applied to the respective temporary estimated first moment for the weight, (ii) a respective weight decay factor for the weight, (iii) the weight, and (iv) the respective learning rate for the weight.

The weight decay factor for the weight is generally received as input by the system and can be, e.g., a constant value that is the same for all of the weights at all of the update iterations, a constant value that is different for different ones of the weights, a dynamic value that is adjusted according to a schedule that depends on an index of the current update iteration, and so on.

In this example, the system can compute a weight decay value for the weight by computing a product between the respective weight decay factor for the weight and the weight and then compute a sum between the weight decay value and the output of the sign function applied to the respective temporary estimated first moment for the weight. The system can then compute the update as a product of the sum and the respective learning rate for the weight.

The system then updates each weight using the respective update for the weight, e.g., by subtracting the respective update from the weight (step 214).

Generally, the system also updates, for each weight, the respective estimated first moment using the respective current gradient of the loss function with respect to the weight (step 216), i.e., and not the temporary estimated first moment. The system then uses the updated (or “final”) estimated first moment as the estimated first moment at the next iteration.

Thus, the “temporary” estimated first moment for the weight is referred to as temporary because it is only used to determine the respective update at the update iteration and is not used to modify the respective estimated first moment for the next update iteration.

For example, to update, for each weight, the respective estimated first moment using the respective current gradient of the loss function with respect to the weight the system can compute, in accordance with a second interpolation weight, an interpolation between (i) the respective estimated first moment of the gradient for the weight and (ii) the respective current gradient of the loss function with respect to the weight.

In some implementations, the first interpolation weight (used to compute the “temporary” estimate) is different from the second interpolation weight (used to compute the “final” estimate that is used at the next training iteration).

For example, the first interpolation weight can be lower than the second interpolation weight, i.e., places more emphasis on the current gradient in the interpolation. By focusing more on the current gradient when computing the update at a given iteration but remembering longer gradient history for the final estimate, the system can apply updates that lead to a higher quality trained neural network.

As a particular example, the first interpolation weight can be equal to 0.9 while the second interpolation weight is equal to a higher value, e.g., 0.99.

FIG. 3 shows pseudo code 300 for one example of the optimizer at a given update iteration for a given weight (“weight”).

As shown in FIG. 3, the optimizer receives as input the given weight, the current gradient (“gradient”), the maintained estimated first moment (“momentum”) for the given weight, and the learning rate (“lr”) for the given weight.

The optimizer then initializes an update variable to be equal to the temporary estimated first moment, e.g., by computing an interpolation (“interp”) between the gradient and the maintained estimated first moment in accordance with the first interpolation weight (“β₁”).

That is, to compute the interpolation, the system computes (β₁)*momentum−(1−β₁)*gradient.

The system then updates the update variable by applying the sign function (“sign”) the update variable.

The system updates the maintained estimated first moment by computing an interpolation (“interp”) between the gradient and the maintained estimated first moment in accordance with the second interpolation weight (“β₂”).

That is, the system computes (β₂)*momentum−(1−β₂)*gradient.

The system computes the weight decay value (“weight_decay”) by computing a product between the respective weight decay factor (“λ”) for the weight and the weight and then updates the update variable by computing a sum between the weight decay value and the update variable, i.e., that is equal to the output of the sign function applied to the respective temporary estimated first moment for the weight.

The system can then again update the update variable by computing a product of the update variable and the respective learning rate for the weight.

The system then returns the final update variable and the updated momentum estimate. The final update variable is used to update the weight value while the updated momentum value is persisted for the next iteration.

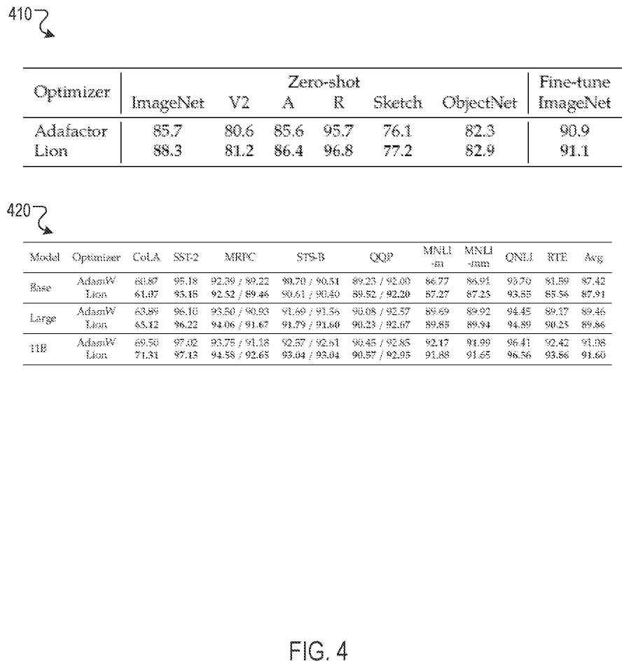

FIG. 4 shows an example 400 of the performance of neural networks trained using the described optimizer.

In particular, FIG. 4 shows a table 410 that shows the performance of a neural network, e.g., a vision Transformer neural network, trained using the described optimizer (“Lion”) and the same neural network trained using the state-of-the-art Adafactor optimizer on a variety of image processing tasks, including tasks that require zero-shot transfer from a training task and a downstream task and tasks that require fine-tuning between the training task and the downstream task. That is, the described optimizer (“Lion”) can be used both for pre-training and then zero-shot transfer or used for both pre-training and fine-tuning.

As can be seen from Table 410, training using the described optimizer improves over training using Adafactor across the range of tasks.

FIG. 4 also shows a Table 420 that shows the performance of three neural network, e.g., three encoder-decoder Transformer neural networks different numbers of parameters (Base, Large, and 11B), trained using the described optimizer (“Lion”) and the same neural networks trained using the state-of-the-art AdamW optimizer on a variety of natural language processing tasks.

As can be seen from Table 420, training using the described optimizer improves over training using AdamW across the range of tasks.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework or a Jax framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method of training a neural network configured to perform a machine learning task by processing a network input in accordance with a set of weights of the neural network to generate a network output for the machine learning task, the method comprising:
maintaining, for each of the weights of the neural network, a respective estimated first moment of a gradient of a loss function for the machine learning task with respect to the weight; and
repeatedly performing operations comprising:
performing, using a plurality of training examples, a training step to obtain respective current gradients of the loss function with respect to each of the weights of the neural network;
determining, for each weight, a respective temporary estimated first moment from the respective estimated first moment of the gradient for the weight and the respective current gradient of the loss function with respect to the weight;
determining, for each weight, an output of a sign function applied to the respective temporary estimated first moment for the weight;
determining, for each weight, a respective update from the output of the sign function applied to the respective temporary estimated first moment for the weight; and
updating each weight using the respective update for the weight.

2. The method of claim 1, wherein the operations further comprise:
updating, for each weight, the respective estimated first moment using the respective current gradient of the loss function with respect to the weight.

3. The method of claim 2, wherein:
updating, for each weight, the respective estimated first moment using the respective current gradient of the loss function with respect to the weight comprises:
computing, in accordance with a second interpolation weight, a second interpolation between (i) the respective estimated first moment of the gradient for the weight and (ii) the respective current gradient of the loss function with respect to the weight.

4. The method of claim 3, wherein:
determining, for each weight, a respective temporary estimated first moment from the respective estimated first moment of the gradient for the weight and the respective current gradient of the loss function with respect to the weight comprises:
computing, in accordance with a first interpolation weight, a first interpolation between (i) a bias corrected version of the respective estimated first moment of the gradient for the weight and (ii) the respective current gradient of the loss function with respect to the weight.

5. The method of claim 3, wherein:
determining, for each weight, a respective temporary estimated first moment from the respective estimated first moment of the gradient for the weight and the respective current gradient of the loss function with respect to the weight comprises:
computing, in accordance with a first interpolation weight, a first interpolation between (i) the respective estimated first moment of the gradient for the weight and (ii) the respective current gradient of the loss function with respect to the weight.

6. The method of claim 5, wherein the first interpolation weight is different from the second interpolation weight.

7. The method of claim 6, wherein the first interpolation weight is lower than the second interpolation weight.

8. The method of claim 7, wherein the first interpolation weight is equal to 0.9.

9. The method of claim 8, wherein the second interpolation weight is equal to 0.99.

10. The method of claim 1, wherein determining, for each weight, a respective update from the output of the sign function applied to the respective temporary estimated first moment for the weight comprises:
determining the respective update from (i) the output of the sign function applied to the respective temporary estimated first moment for the weight, (ii) a respective weight decay factor for the weight, (iii) the weight, and (iv) a respective learning rate for the weight.

11. The method of claim 10, wherein updating each weight using the respective update for the weight comprises:
subtracting the respective update from the weight.

12. One or more non-transitory computer-readable media storing instructions that when executed by one or more computers cause the one or more computers to perform first operations for training a neural network configured to perform a machine learning task by processing a network input in accordance with a set of weights of the neural network to generate a network output for the machine learning task, the operations comprising:
maintaining, for each of the weights of the neural network, a respective estimated first moment of a gradient of a loss function for the machine learning task with respect to the weight; and
repeatedly performing operations comprising:
performing, using a plurality of training examples, a training step to obtain respective current gradients of the loss function with respect to each of the weights of the neural network;
determining, for each weight, a respective temporary estimated first moment from the respective estimated first moment of the gradient for the weight and the respective current gradient of the loss function with respect to the weight;
determining, for each weight, an output of a sign function applied to the respective temporary estimated first moment for the weight;
determining, for each weight, a respective update from the output of the sign function applied to the respective temporary estimated first moment for the weight; and
updating each weight using the respective update for the weight.

13. One or more non-transitory computer-readable media storing instructions that when executed by one or more computers cause the one or more computers to perform first operations for training a neural network configured to perform a machine learning task by processing a network input in accordance with a set of weights of the neural network to generate a network output for the machine learning task, the first operations comprising:
maintaining, for each of the weights of the neural network, a respective estimated first moment of a gradient of a loss function for the machine learning task with respect to the weight; and
repeatedly performing second operations comprising:
performing, using a plurality of training examples, a training step to obtain respective current gradients of the loss function with respect to each of the weights of the neural network;
determining, for each weight, a respective temporary estimated first moment from the respective estimated first moment of the gradient for the weight and the respective current gradient of the loss function with respect to the weight;
determining, for each weight, an output of a sign function applied to the respective temporary estimated first moment for the weight;
determining, for each weight, a respective update from the output of the sign function applied to the respective temporary estimated first moment for the weight; and
updating each weight using the respective update for the weight.

14. A system comprising one or more computers and one or more storage devices storing instructions that when executed by the one or more computers cause the one or more computers to perform first operations for training a neural network configured to perform a machine learning task by processing a network input in accordance with a set of weights of the neural network to generate a network output for the machine learning task, the first operations comprising:
maintaining, for each of the weights of the neural network, a respective estimated first moment of a gradient of a loss function for the machine learning task with respect to the weight; and
repeatedly performing second operations comprising:
performing, using a plurality of training examples, a training step to obtain respective current gradients of the loss function with respect to each of the weights of the neural network;
determining, for each weight, a respective temporary estimated first moment from the respective estimated first moment of the gradient for the weight and the respective current gradient of the loss function with respect to the weight;
determining, for each weight, an output of a sign function applied to the respective temporary estimated first moment for the weight;
determining, for each weight, a respective update from the output of the sign function applied to the respective temporary estimated first moment for the weight; and
updating each weight using the respective update for the weight.

15. The system of claim 14, wherein the second operations further comprise:
updating, for each weight, the respective estimated first moment using the respective current gradient of the loss function with respect to the weight.

16. The system of claim 15, wherein:
updating, for each weight, the respective estimated first moment using the respective current gradient of the loss function with respect to the weight comprises:
computing, in accordance with a second interpolation weight, a second interpolation between (i) the respective estimated first moment of the gradient for the weight and (ii) the respective current gradient of the loss function with respect to the weight.

17. The system of claim 16, wherein:
determining, for each weight, a respective temporary estimated first moment from the respective estimated first moment of the gradient for the weight and the respective current gradient of the loss function with respect to the weight comprises:
computing, in accordance with a first interpolation weight, a first interpolation between (i) a bias corrected version of the respective estimated first moment of the gradient for the weight and (ii) the respective current gradient of the loss function with respect to the weight.

18. The system of claim 16, wherein:
determining, for each weight, a respective temporary estimated first moment from the respective estimated first moment of the gradient for the weight and the respective current gradient of the loss function with respect to the weight comprises:
computing, in accordance with a first interpolation weight, a first interpolation between (i) the respective estimated first moment of the gradient for the weight and (ii) the respective current gradient of the loss function with respect to the weight.

19. The system of claim 18, wherein the first interpolation weight is different from the second interpolation weight.

20. The system of claim 19, wherein the first interpolation weight is lower than the second interpolation weight.
